(19) United States
(12) Patent Application Publication
(10) Pub. No.: US 2013/0021013 A1
(43) Pub. Date: Jan. 24, 2013

(54) SWITCHING POWER SUPPLY APPARATUS

(71) Applicant: Satoshi Kondou, Niiza-shi (JP)

(72) Inventor: Satoshi Kondou, Niiza-shi (JP)

(21) Appl. No.: 13/552,306

(22) Filed: Jul. 18, 2012

(30) Foreign Application Priority Data
Jul. 20, 2011 (JP) 2011-158863

(51) Int. Cl. G05F 1/56

(52) U.S. Cl. 323/283

(57) ABSTRACT

Switching power supply apparatus, which allows steady-state power consumption due to starting current supply circuit to be cut is provided. Comprising a starting current supply circuit which, at turn-on of an input power supply, from a high-voltage power supply provided by input power supply or a high-voltage positive electrode of a switching device, supplies an operating current to a switching control circuit through a switch element comprised of a depression mode FET; and a steady-state current supply circuit which supplies the operating current to the switching control circuit, using a low-voltage power supply provided by a secondary electromotive force of a transformer after start of the switching operation, the apparatus uses the low-voltage power supply to supply a bias voltage to a path of a leakage current flowing from the high-voltage power supply to a grounding terminal through the switch element in the off-state, thereby blocking the leakage current.

### BACKGROUND OF THE INVENTION

1. Field of the Invention

The present invention relates to a switching power supply apparatus for effecting output voltage control through a switching operation, and particularly to a switching power supply apparatus having a start-up circuit.

2. Description of the Related Art

The switching power supply apparatus for effecting output voltage control through a switching operation includes a switching device connected in series with an input power supply and a primary winding of a transformer, and a switching control circuit which controls the switching device on/off for causing it to make a switching operation, and is configured such that it rectifies and smoothes a secondary electromotive force generated in a secondary winding of the transformer for outputting direct current power. Supplying an operating current to the switching control circuit is generally performed by a current supply circuit which uses a secondary electromotive force generated in an auxiliary winding of the transformer, however, since the secondary electromotive force cannot be used at start-up, a starting current supply circuit which directly uses the input power supply is provided (for example, Patent Document 1 to be referenced).

FIG. 5 is a circuit configuration diagram illustrating a circuit configuration of a conventional switching power supply apparatus.

To alternating input terminals ACin1 and ACin2 of a rectification circuit DB in which diodes are bridge configured, a commercial alternating current power supply AC is connected, and an alternating current voltage input from the commercial alternating current power supply AC is full-wave rectified to be output from the rectification circuit DB. A smoothing capacitor C1 is connected across a rectified output positive terminal and a rectified output negative terminal of the rectification circuit DB. In addition, the rectified output negative terminal of the rectification circuit DB is connected to a grounding terminal. Thereby, a direct current power supply as a result of rectifying and smoothing the current from the commercial alternating current power supply AC with the rectification circuit DB and the smoothing capacitor C1 is produced.

A transformer T for supplying power from a primary side (an input side) to a secondary side (a load 2 side) is comprised of a primary winding P1, an auxiliary winding P2, and a secondary winding S1. Across the rectified output positive terminal of the rectification circuit DB and the grounding terminal, the primary winding P1 of the transformer T and a switching device Q1, such as a power MOSFET (Metal Oxide Semiconductor Field Effect Transistor), or the like, are connected in series. A gate terminal of the switching device Q1 is connected to a switching control circuit 1. Thereby, the switching control circuit 1 controls the switching device Q1 on/off, the power given to the primary winding P1 of the transformer T being transmitted to the secondary winding S1 of the transformer T, resulting in a pulsating current being generated in the secondary winding S1 of the transformer T.

Across both terminals of the secondary side winding S1 of the transformer T, a smoothing capacitor C2 is connected through a rectifying diode D1, and a secondary electromotive force induced in the secondary side winding S1 of the transformer T is rectified and smoothed by the rectifying diode D1 and the smoothing capacitor C2 to be supplied to a load (RL) 2 as direct current power. In addition, the line connected to a positive electrode terminal of the smoothing capacitor C2 provides a power line, while the line to which a negative electrode terminal of the smoothing capacitor C2 is connected provides a GND line connected to a grounding terminal.

Across the power line and the GND line, a light-emitting diode PCD of a photocoupler and an error amplifier 3 are connected in series. The error amplifier 3 is connected across the power line and the GND line, and controls the current flowing in the light-emitting diode PCD of the photocoupler in accordance with the difference between the output voltage and the reference voltage in the inside (not shown). In addition, to the switching control circuit 1, a light-receiving transistor PCTR is connected, and a feedback (FB) signal in accordance with the output voltage is transmitted from the light-emitting diode PCD on the secondary side to the light-receiving transistor PCTR on the primary side and is input to the switching control circuit 1.

Across both terminals of the auxiliary winding P2 of the transformer T, a smoothing capacitor C3 is connected through a rectifying diode D2, and a connection point between the rectifying diode D2 and the smoothing capacitor C3 is connected to the switching control circuit 1 and a start-up control circuit 4. The auxiliary winding P2 of the transformer T, the rectifying diode D2, and the smoothing capacitor C3 function as a steady-state current supply circuit for supplying an operating current to the switching control circuit 1; the secondary electromotive force generated in the auxiliary winding P2 is rectified and smoothed by the diode D2; and the smoothing capacitor C3 to be supplied to the switching control circuit 1 and the start-up control circuit 4.

To a connection point between the rectified output positive terminal of the rectification circuit DB and the primary winding P1 of the transformer T, a drain terminal of a switch element N1 comprised of a depression mode FET is connected, and across a gate terminal and a source terminal of the switch element N1, a resistor R1 for biasing is connected. In addition, the source terminal of the switch element N1 is connected to a connection point between the rectifying diode D2 and the smoothing capacitor C3 through the resistor R2, and the gate terminal of the switch element N1 is connected to a grounding terminal through a switch element N2 comprised of an npn bipolar transistor.

Turning on and off of the switch element N2 is controlled by the start-up control circuit 4. Immediately after turn-on of the commercial alternating current power supply AC, the switch element N2 is brought into the off-state by the start-up control circuit 4, the gate-source voltage of the switch element N1 becoming 0 volts, thereby the switch element N1 being brought into the on-state. Thus, through the switch element N1, an operating current is supplied to the switching control circuit 1 and the start-up control circuit 4. The resistor R2 is an element for limiting the current flowing in the switch element N1 in the on-state. The switch element N1, the resistors R1 and R2, the switch element N2, and the start-up control circuit 4 function as a starting current supply circuit.

When, on an FB signal from the secondary side, it is detected that the secondary electromotive force of the transformer T has risen, the start-up control circuit 4 turns the switch element N2 on, thereby bringing the switch element N1 into the off-state. Thus, in the steady state, the secondary electromotive force generated in the auxiliary winding P2 is rectified and smoothed by the diode D2 and the smoothing capacitor C3 to be supplied as an operating current for the switching control circuit 1 and the start-up control circuit 4. In addition, the resistor R1 is an element for limiting the current flowing along a path from the switch element N1 to the switch element N2 via the resistor R1 when the switch element N1 is in the off-state, and has a resistance value several hundred to one thousand times as great as that of the resistor R2.

In addition, as the switching power supply apparatus shown in FIG. 5, in the case where, the switching device Q1 and the switching control circuit 1 are formed in an integrated circuit as illustrated with a dotted line, an ST terminal, a D terminal, a GND terminal, an FB terminal, and a Vcc terminal are provided. The ST terminal is a terminal to which the drain terminal of the switch element N1 is connected, and to which the input power supply, i.e., a connection point between the positive electrode terminal of the smoothing capacitor C1 and one end of the primary winding P1 of the transformer T is connected. The D terminal is a terminal to which a drain terminal of the switching device Q1 is connected, and to which the other end of the primary winding P1 of the transformer T is connected. To the GND terminal, a grounding terminal is connected, and to the FB terminal, an FB signal from the secondary side is input. In addition, the Vcc terminal is a terminal to which an operating voltage Vcc for the switching control circuit 1 and the start-up control circuit 4 is applied, and a connection point between the rectifying diode D2 and to which the positive electrode terminal of the smoothing capacitor C3 is connected.

Herein, the ST terminal and the D terminal are terminals to which a high voltage is input. If, like this, there are two terminals to which a high voltage is input, a large-scale measure for insulation between the terminals is required, and thus, providing a D/ST terminal, which commonizes the D terminal and the ST terminal, for commonizing input to the drain terminal of the switching device Q1 and input to the drain terminal of the switch element N1 as shown in FIG. 6 is practiced. In this case, there is the possibility that, during operation, the voltage at the Vcc terminal may be higher than the voltage at the D/ST terminal, and therefore, a circuit (a diode D3) for prevention of a backflow from the Vcc terminal to the D/ST terminal is provided in the starting current supply circuit.

### CITATION LIST

### Patent Document

Patent Document 1

Japanese Unexamined Patent Application Publication No. 2000-23461

However, with the prior art circuit shown in FIG. 5, the switch element N1 is steadily in the off-state, thereby allowing the steadily occurring power loss to be cut, however, since the switch element N2 is in the on-state, a leakage current of 50 microamperes or less flows along a path from the switch element N1 to the switch element N2 via the resistor R1. The steadily flowing leakage current is as low as no more than 50 microamperes; however, the drain voltage of the switch element N1 is high; and thus, there is a problem that the power consumption is high. Assuming that the gate-source voltage of the switch element N1 with the switch element N2 being in the on-state is −5 volts (the source voltage Vs of the switch element N1 is 5 volts), and the resistor R1 is 2.5 megohms, the leakage current (drain current) will be 2 micro-amperes, and if the drain voltage of the switch element N1 is 380 volts, the power consumption of the switch element N1 will be 0.78 mW.

In addition, with the prior art circuit shown in FIG. 6, there has been presented a problem that the drain voltage of the switch element N1 is boosted by the transformer T, thereby the power consumption of the switch element N1 being further increased. Assuming that the gate-source voltage of the switch element N1 with the switch element N1 being in the on-state is −5 volts (the source voltage Vs of the switch element N1 is 5 volts), and the resistor R1 is 2.5 megohms; the leakage current will be 2 micro-amperes; and if the drain voltage of the switch element N1 is 500 volts, the power consumption of the switch element N1 will be 1 mW.

In view of the aforementioned problems of the prior art, the present invention has been made to solve such problems and provide a switching power supply apparatus, which can cut the steady-state power consumption due to the starting current supply circuit.

### SUMMARY OF THE INVENTION

According to an aspect of the present invention, there is provided a switching power supply apparatus having a switching device connected in series with an input power supply and a primary winding of a transformer, and a switching control circuit for controlling the switching device on/off to cause it to make a switching operation, rectifying and smoothing a secondary electromotive force generated in the transformer for outputting direct current power, the switching power supply apparatus comprising: a starting current supply circuit using, upon turn-on of the input power supply, a high-voltage power supply provided by the input power supply or a high-voltage positive electrode of the switching device to supply an operating current to the switching control circuit, a steady-state current supply circuit using, in a steady state after the switching operation having been started, a low-voltage power supply provided by a secondary electromotive force of the transformer to supply an operating current to the switching control circuit, a start-up control circuit for setting the starting current supply circuit to the off-state in the steady state, and a bias voltage supply circuit using the low-voltage power supply to supply a bias voltage to a path of a leakage current flowing from the high-voltage power supply to a grounding terminal through the starting current supply circuit when the starting current supply circuit is in the off-state, thereby blocking or reducing the leakage current.

According to another aspect of the present invention, there is provided a switching power supply apparatus, wherein the starting current supply circuit comprises a depression mode FET for turning supply of an operating current to the switching control circuit on/off, the bias voltage supply circuit supplying the bias voltage to a source terminal of the depression mode FET, thereby blocking the leakage current.

According to another aspect of the present invention, there is provided a switching power supply apparatus, wherein the starting current supply circuit comprises an enhancement mode FET for turning supply of an operating current to the switching control circuit on/off, and a junction FET using the high-voltage power supply to supply an on-voltage to a gate terminal of the enhancement mode FET, the bias voltage supply circuit using the low-voltage power supply to supply a bias voltage to a path of a leakage current flowing from the high-voltage power supply to a grounding terminal through the junction FET, thereby blocking or reducing the leakage current.

According to another aspect of the present invention, there is provided a switching power supply apparatus, wherein the starting current supply circuit comprises an enhancement mode FET for turning supply of an operating current to the switching control circuit on/off, and a depression mode FET using the high-voltage power supply to supply an on-voltage to a gate terminal of the enhancement mode FET, the bias voltage supply circuit using the low-voltage power supply to supply a bias voltage to a path of a leakage current flowing from the high-voltage power supply to a grounding terminal through the junction FET, thereby blocking or reducing the leakage current.

In accordance with the present invention, there is provided an advantage that, by using the low-voltage power supply for supplying a bias voltage to a path of a leakage current flowing from the high-voltage power supply to a grounding terminal through the starting current supply circuit when the starting current supply circuit is brought into the off-state, thereby blocking or reducing the leakage current, the steady-state power consumption due to the starting current supply circuit can be cut.

### BRIEF DESCRIPTION OF THE DRAWINGS

FIG. 1 is a circuit configuration diagram illustrating a circuit configuration of a first embodiment of a switching power supply apparatus according to the present invention;

FIG. 2 is a circuit configuration diagram illustrating a circuit configuration of a starting current supply circuit in a second embodiment of the switching power supply apparatus according to the present invention;

FIG. 3 is an equivalent circuit diagram of the starting current supply circuit shown in FIG. 2;

FIG. 4 is a circuit configuration diagram illustrating a circuit configuration of a starting current supply circuit in a third embodiment of the switching power supply apparatus according to the present invention;

FIG. 5 is a circuit configuration diagram illustrating a circuit configuration of a conventional switching power supply apparatus; and

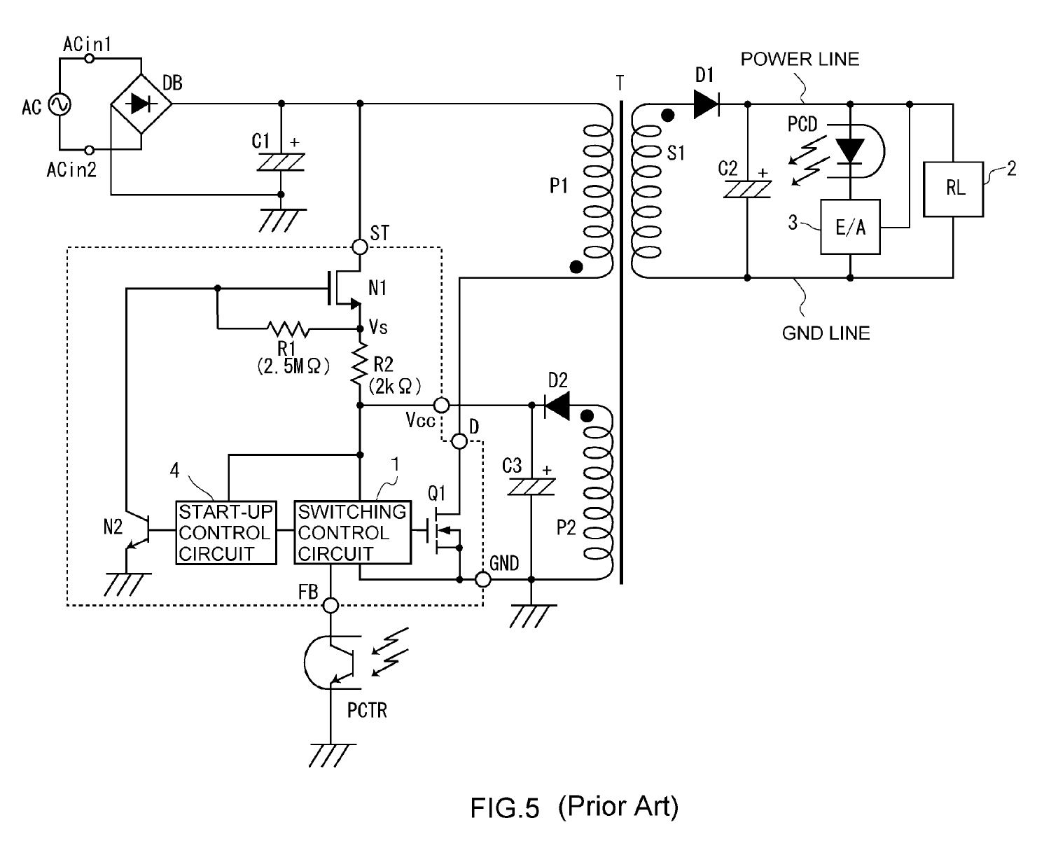

FIG. 6 is a circuit configuration diagram illustrating a circuit configuration of a conventional switching power supply apparatus in which a D terminal and an ST terminal are commonized.

### DETAILED DESCRIPTION OF THE PREFERRED EMBODIMENT

### First Embodiment

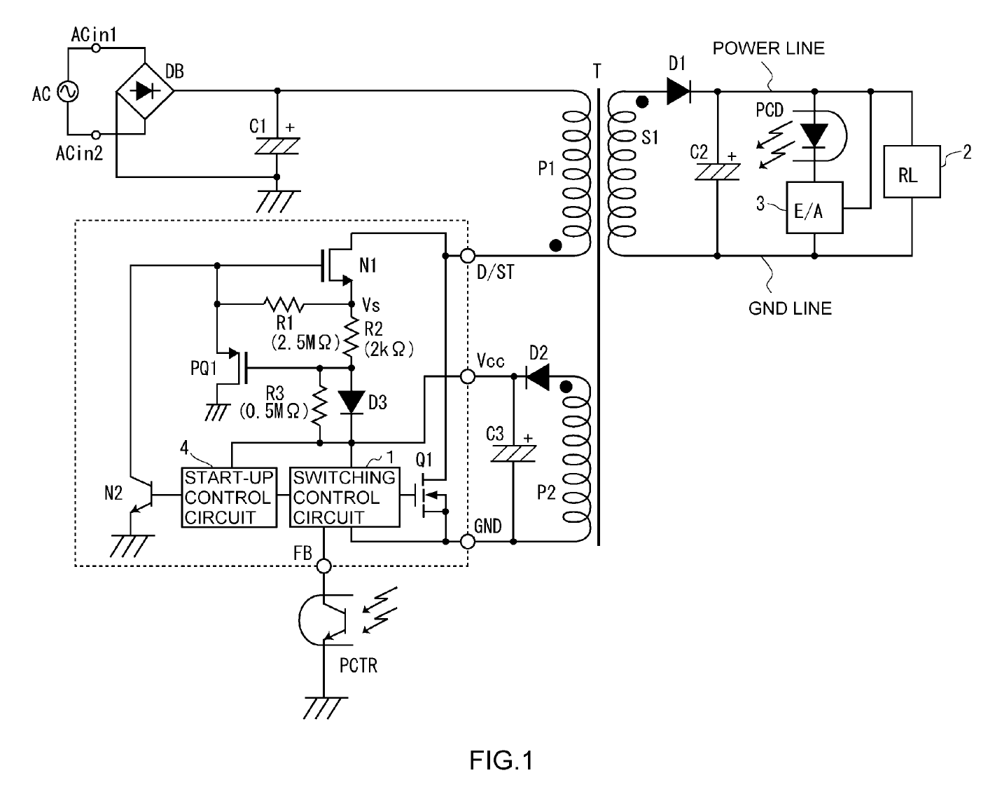

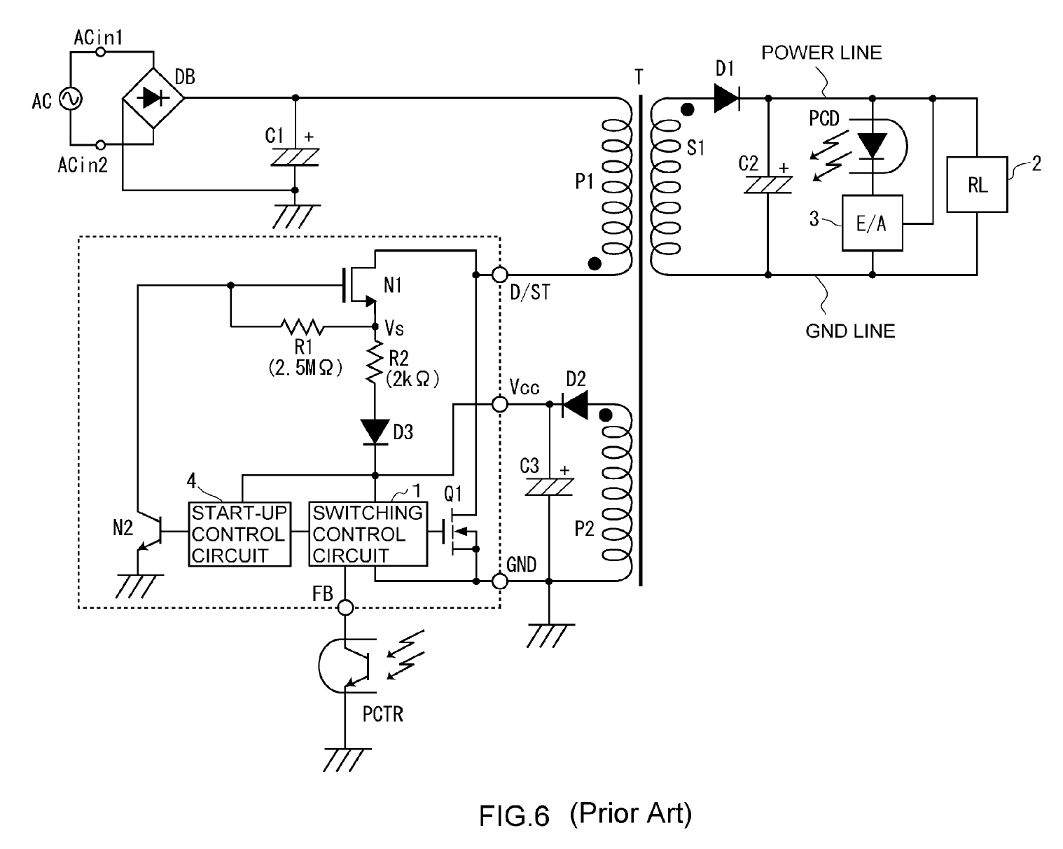

As refer to FIG. 1, a switching power supply apparatus of a first embodiment, in addition to the configuration of the starting current supply circuit in the conventional switching power supply apparatus shown in FIG. 6, a resistor R3 connected in parallel with a diode D3 is provided, and a switch element PQ1 comprised of a P-channel enhancement mode FET, which is for a constant current circuit for preventing fluctuation of the current flowing in the resistor R2, is also provided. A source terminal of the switch element PQ1 is connected to a connection point between the gate terminal of the switch element N1 and the resistor R1, and a drain terminal of the switch element PQ1 is connected to a grounding terminal. In addition, a gate terminal of the switch element PQ1 is connected to a connection point between the diode D3 and the resistor R2.

When the switch element N1 is in the on-state immediately after the commercial alternating current power supply AC being turned on (in the start-up), current flows in the resistor R3 and the diode D3 connected in parallel to charge the smoothing capacitor C3, and once the charged voltage of the smoothing capacitor C3 reaches a predetermined voltage, the switching control circuit 1 is turned on for starting a switching operation. At the same time, the start-up control circuit 4 brings the switch element N2 into the on-state to turn the switch element N1 off.

When a steady state has been reached, the switch element N1 being brought into the off-state, the source voltage Vs for the switch element N1 becomes a voltage dividing the operating voltage Vcc in the steady state by the resistor R3 and resistor R2 with the resistor R1. Therefore, the source voltage Vs of the switch element N1 is determined by the resistance value of the resistor R3. In the first embodiment, the resistance value of the resistor R3 is set such that the potential difference between the source voltage Vs of the switch element N1 and the gate voltage (0 volts) of the switch element N1, that is, the gate-source voltage of the element N1 is the pinch-off voltage or less. The resistor R3 functions as a bias voltage supply circuit. In other words, thereby, to a connection point between the resistor R2 and the resistor R1, a bias voltage for blocking a leakage current (drain current) flowing from the D/ST terminal, which provides a high-voltage power supply, to the switch element N1 is supplied from the Vcc terminal, which provides a low-voltage power supply, through the resistor R3. Therefore, in the steady state, a current flows from the Vcc terminal, which provides an operating voltage lower than the drain voltage of the switch element N1, along a path from the resistor R3 to the switch element N2 via the resistor R2 and the resistor R1, with no leakage current flowing in the switch element N1. Thus, the power consumption is to be reduced.

In the case where the operating voltage Vcc is 9 volts, which is a minimum operating voltage, and if, as shown in FIG. 1, the resistor R1 is 2.5 megohms, the resistor R3 is 0.5 megohm, and the resistance value of the resistor R2 is neglected, since it is small enough as compared to the resistance value of the resistor R3, the source voltage Vs for the switch element N1 will be 7.5 volts. Herein, if the −7.5 volts is a voltage which is no more than the pinch-off voltage of the switch element N1, no leakage current will flow in the switch element N1, and a current of 3 microamperes will flow along a path from the terminal Vcc (9 volts) to the switch element N2 via the resistor R3, the resistor R2, and the resistor R1. Therefore, the power consumption will be 9 volts×3 microamperes=0.027 milliwatt, whereby the power consumption can be greatly reduced as compared to the conventional technology.

In the case where the operating voltage Vcc is 30 volts, which is a maximum operating voltage, the source voltage Vs of the switch element N1 will be 25 volts, and a current of 10 microamperes will flow along a path from the Vcc terminal (30 volts) to the switch element N2 via the resistor R3, the resistor. R2, and the resistor R1. Therefore, the power consumption will be 30 volts×10 microamperes=0.3 milliwatt, whereby, also in this case, the power consumption can be greatly reduced as compared to the prior art.

As described above, according to the first embodiment, there will be provided an advantage that, when the switch element N1 is in the off-state, to a path of a leakage current flowing from the high-voltage power supply to a grounding terminal through the switch element N1, a bias voltage to block the leakage current by using the low-voltage power supply from the terminal Vcc is provided via the resistor R3. Thus, the steady-state power consumption can be cut.

### Second Embodiment

In the second embodiment, in order to accommodate the case where the structure of the chip makes it impossible to use a depression mode FET, an enhancement mode FET and a junction FET (junction gate field-effect transistor) are combined to configure a starting current supply circuit.

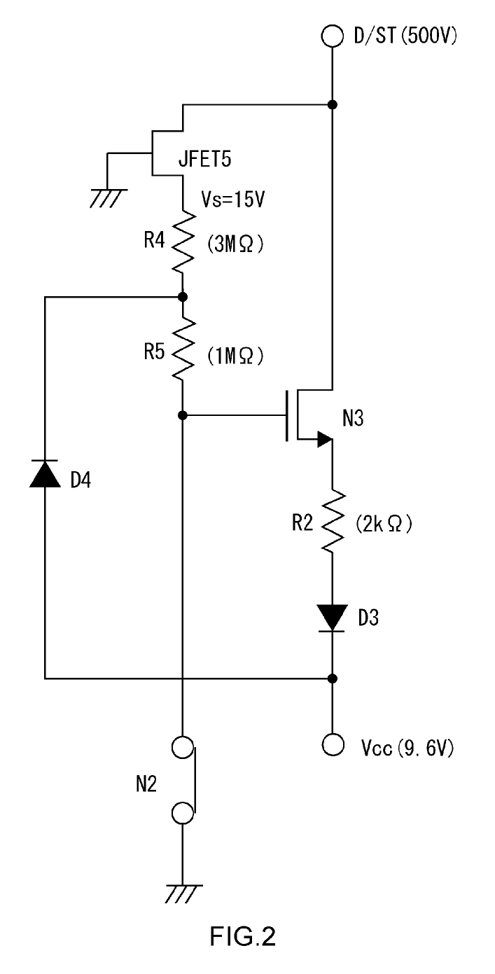

As refer to FIG. 2, a switch element N3 comprised of an N channel MOSFET, a resistor R2, and a diode D3 are connected in series across the D/ST terminal and the Vcc terminal. In addition, across the D/ST terminal and the grounding terminal, a JFET5, resistors R4 and R5, and a switch element N2 are connected in series; a gate terminal of the JFET5 is connected to the grounding terminal; and a connection point between the resistor R5 and the switch element N2 is connected to a gate terminal of the switch element N3 When the switch element N2 is in the off-state (in the start-up), the JFET5 uses the high-voltage power supply, which is provided by the D/ST terminal, to supply an on-voltage to the gate terminal of the switch element N3. Further, to the Vcc terminal, the anode of the diode D4 is connected, and the cathode of the diode D4 is connected to a connection point between the resistor R4 and the resistor R5.

Herein, assuming that the voltage input to the D/ST terminal is 500 volts; the operating voltage Vcc is 9.6 volts; the source voltage of the JFET5 when the switch element N2 is in the on-state is 15 volts; the resistance value of the resistor R4 is 3 megohms; the resistance value of the resistor R5 is 1 megohm; the forward voltage of the diode D4 is 0.6 volt; and when the switch element N2 is in the on-state (in the steady state,) the power consumption in the case of the diode D4 being not connected and in the case of the diode D4 being connected as shown in FIG. 2 are verified.

In FIG. 2, in the case where the diode D4 is not connected, a leakage current of 3.75 micro-amperes will flow in the JFET5, the power consumption becomes 500 volts×3.75 microamperes=1.88 mW.

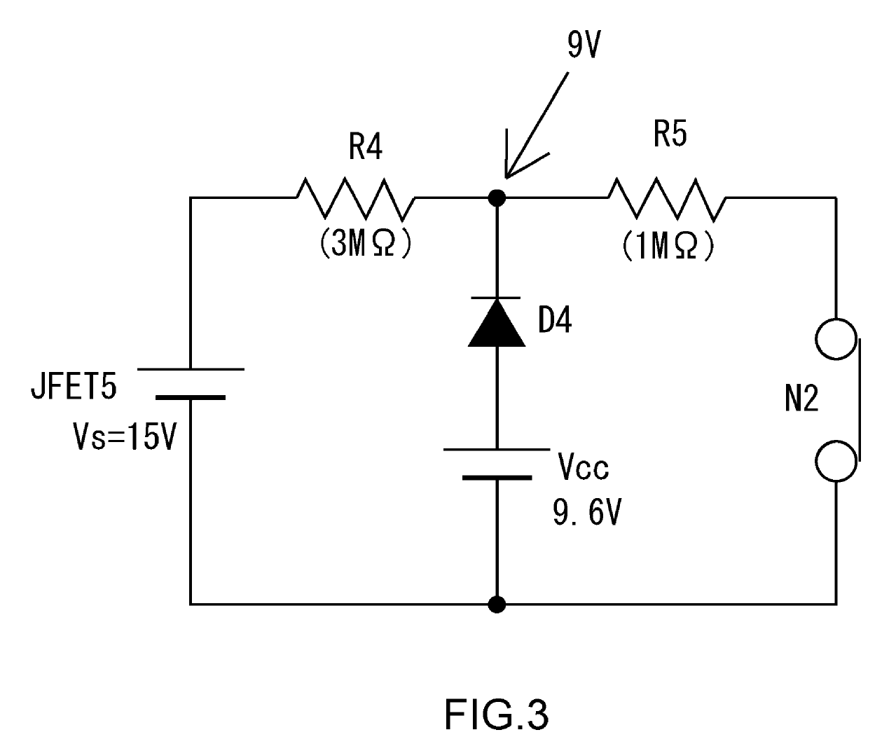

Contrarily to this, as shown in FIG. 2, in the case where the diode D4 is connected, as can be seen from the equivalent circuit shown in FIG. 3, the voltage at a connection point between the resistor R4 and the resistor R5 is 9 volts, the leakage current flowing in the JFET5 will be reduced down to 2 micro-amperes. The diode D4 functions as a bias voltage supply circuit. In other words, to the connection point between the resistor R4 and the resistor R5, a bias voltage which reduces the leakage current flowing from the D/ST terminal, which provides a high-voltage power supply, to the JFET5 is supplied from the Vcc terminal, which provides a low-voltage power supply, through the diode D4. Therefore, the power consumption resulting from the voltage input to the D/ST terminal, which is 500 volts, will be 500 volts×2 microamperes=1 mW, and the power consumption resulting from the operating voltage Vcc (9.6 volts) will be (9.6 volts)²×1 megohm=0.09 mW, whereby the total power consumption can be reduced down to 1.09 mW.

In the case where the operating voltage Vcc is 12.6 volts, the voltage at the connection point between the resistor R4 and the resistor R5 will be 12 volts, the leakage current flowing in the JFET5 being reduced down to 1 micro-ampere. Therefore, the power consumption resulting from the voltage input to the D/ST terminal, which is 500 volts, will be 500 volts×1 micro-ampere=0.5 mW, and the power consumption resulting from the operating voltage Vcc, 12.6 volts, will be (12.6 volts)²×1 megohms=0.16 mW, whereby the total power consumption can be further reduced down to 0.66 mW.

As described above, according to the second embodiment, there will be provided an advantage that, when the switch element N3 is in the off-state, to a path of a leakage current flowing from the high-voltage power supply to a grounding terminal through the JFET5, a bias voltage to block the leakage current by using the low-voltage power supply from the Vcc terminal is provided through the diode D4. Thus, the steady-state power consumption can be cut.

### Third Embodiment

In the third embodiment, a depression mode FET and an enhancement mode FET are combined to configure a starting current supply circuit.

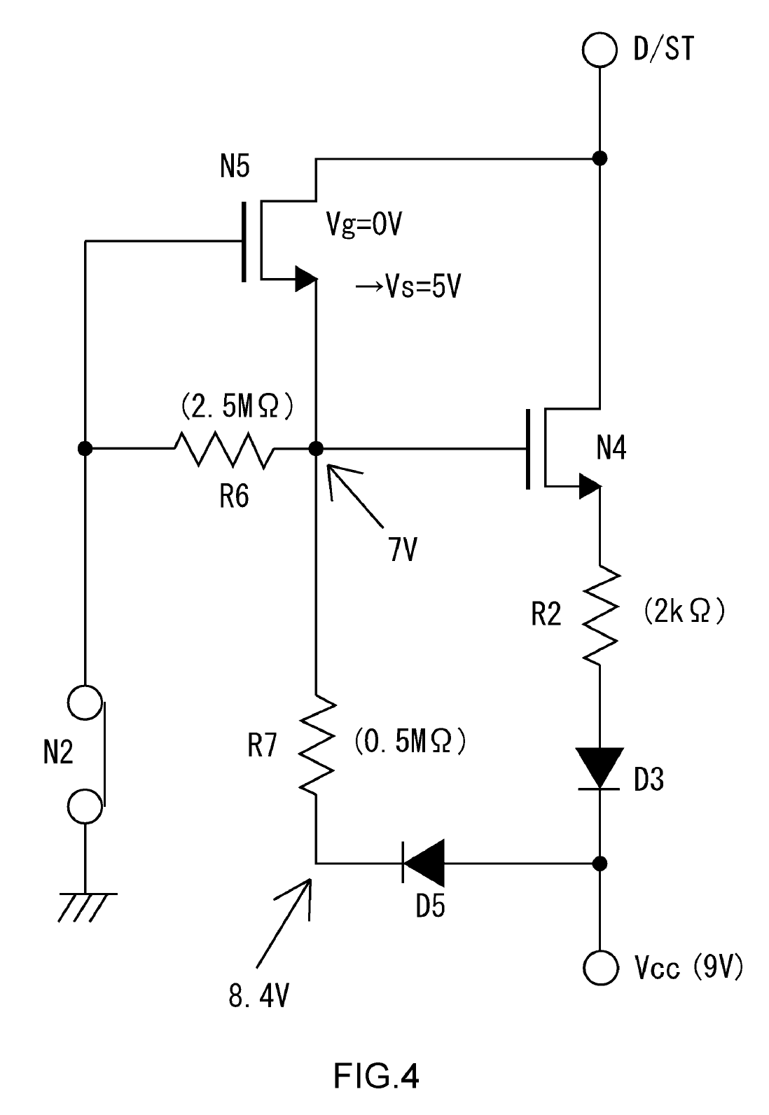

As refer to FIG. 4, across the D/ST terminal and the Vcc terminal, a switch element N4 comprised of an enhancement mode MOS transistor, a resistor R2, and a diode D3 are connected in series. A drain terminal of a switch element N5 comprised of a depression mode FET is connected to the D/ST terminal, and a source terminal of the switch element N5 is connected to a gate terminal of the switch element N4. Agate terminal of the switch element N5 is connected to a grounding terminal through the switch element N2, and across the gate terminal and the source terminal of the switch element N5, a resistor R6 is connected. In addition, to the Vcc terminal, the anode of a diode D5 is connected, and the cathode of the diode D5 is connected to a connection point between the source terminal of the switch element N5 and the gate terminal of the switch element N4 through a resistor R7. When the switch element N2 is in the off-state (in the start-up), the switch element N5 uses the high-voltage power supply, which is provided by the D/ST terminal, to supply an on-voltage to the gate terminal of the switch element N4.

Herein, assuming that the voltage input to the D/ST terminal is 500 volts; the operating voltage Vcc is 9 volts; the source voltage of the switch element N5 when the switch element N2 is in the on-state is 5 volts; the resistance value of the resistor R6 is 2.5 megohms; the resistance value of the resistor R7 is 0.5 megohm; forward voltage of the diode D4 is 0.6 volt; and when the switch element N2 is in the on-state (in the steady state), the power consumption in the case where the diode D5 is not connected and in the case where the diode D5 is connected as shown in FIG. 4 are verified.

In FIG. 4, in the case where the diode D5 is not connected, a leakage current of 2 micro-amperes will flow in the switch element N5, the power consumption being 500 volts×2 micro-amperes=1 mW.

Contrarily to this, as shown in FIG. 4, in the case where the diode D5 is connected, the voltage at the connection point between the resistor R6 and the resistor R7 will be 7 volts. The diode D5 and the resistor R7 function as a bias voltage supply circuit. In other words, to the connection point between the resistor R6 and the resistor R7, a bias voltage for blocking a leakage current flowing from the D/ST terminal, which provides a high-voltage power supply, to the switch element N5 is supplied from the Vcc terminal, which provides a low-voltage power supply, through the diode D5 and resistor R7. Further, the resistor R7 is provided in order to drop the operating voltage Vcc to a voltage which is higher than the source voltage of the switch element N5 when the switch element N2 is in the on-state, and which is lower than the pinch-off voltage of the switch element N4. Since the voltage at the connection point between the resistor R6 and the resistor R7 is higher than 5 volts, a current of 3 micro-amperes flows from the Vcc terminal (9 volts) along a path from the resistor R7 to the switch element N2 via the resistor R6, with no leakage current flowing in the switch element N5. Therefore, the power consumption will be 9 volts×3 microamperes=0.027 mW, whereby the power consumption can be greatly reduced.

As described above, according to the third embodiment, there will be provided an advantage that, while the switch element N4 is in the off-state, to a path of a leakage current flowing from the high-voltage electrode to a grounding terminal through the switch element N5, a bias voltage to block the leakage current by using the low-voltage power supply from the Vcc terminal, is provided through the diode D5 and the resistor R7. Thus, the steady-state power consumption can be cut.

Heretofore, the preferred embodiments of the present invention have been explained. However, such embodiments are only an exemplification, and various changes and modifications thereof may be made without departing from the spirit and the scope thereof.

What is claimed is:

1. A switching power supply apparatus having a switching device connected in series with an input power supply and a primary winding of a transformer, and a switching control circuit for controlling the switching device on/off to make a switching operation, which outputs direct current power by rectifying and smoothing a secondary electromotive force generated in the transformer, which comprising:
a starting current supply circuit, at turn-on of the input power supply, to supply an operating current to the switching control circuit by using the input power supply or a high-voltage power supply provided by a high-voltage positive electrode of the switching device;
a steady-state current supply circuit, in a steady state after the switching operation having been started, to supply an operating current to the switching control circuit by using a low-voltage power supply provided by a secondary electromotive force of the transformer;
a start-up control circuit for setting the starting current supply circuit to the off-state in the steady state; and
a bias voltage supply circuit, when the starting current supply circuit is in the off-state, to a path of a leakage current flowing from the high-voltage power supply to a grounding terminal through the starting current supply circuit, to supply a bias voltage for blocking or reducing the leakage current by using the low-voltage power supply.

2. The switching power supply apparatus of claim 1, wherein the starting current supply circuit comprises a depression mode FET for turning supply of an operating current to the switching control circuit on/off; and
the bias voltage supply circuit supplying the bias voltage for blocking the leakage current to a source terminal of the depression mode FET.

3. The switching power supply apparatus of claim 1, wherein the starting current supply circuit comprises an enhancement mode FET for turning supply of an operating current to the switching control circuit on/off, and
a junction FET to supply an on-voltage to a gate terminal of the enhancement mode FET by using the high-voltage power supply, wherein
the bias voltage supply circuit, to a path of a leakage current flowing from the high-voltage power supply to a grounding terminal through the junction FET, to supply a bias voltage for blocking or reducing the leakage current by using the low-voltage power supply.

4. The switching power supply apparatus of claim 1, wherein the starting current supply circuit comprises an enhancement mode FET for turning supply of an operating current to the switching control circuit on/off, and
a depression mode FET to supply an on-voltage to a gate terminal of the enhancement mode FET by using the high-voltage power supply, wherein
the bias voltage supply circuit, to a path of a leakage current flowing from the high-voltage power supply to a grounding terminal through the junction FET, to supply a bias voltage for blocking or reducing the leakage current by using the low-voltage power supply.
